(19) United States
(12) Patent Application Publication
(10) Pub. No.: US 2026/0292554 A1
(43) Pub. Date: Sep. 24, 2026

(54) DEVICES, METHODS, APPARATUSES, AND COMPUTER READABLE MEDIA FOR PERFORMING MEASUREMENTS WITH GAPS

(71) Applicant: Nokia Technologies Oy, Espoo (FI)

(72) Inventors: Bent Henneburg Rysgaard, Aalborg (DK); Rafael Cauduro Dias De Paiva, Aalborg (DK); Juergen Hofmann, Merching (DE); Ping Yuan, Chaoyang District Beijing (CN)

(73) Assignee: Nokia Technologies Oy, Espoo (FI)

(21) Appl. No.: 19/473,987

(22) PCT Filed: Apr. 10, 2023
(86) PCT No.: PCT/CN2023/087221

§ 371 Date: Oct. 9, 2025

(51) Int. Cl. H04W 24/08

(52) U.S. Cl. CPC H04W 24/08

(57) ABSTRACT

Various example embodiments relate to devices, methods, apparatuses and computer readable media for performing measurements with gaps. An example terminal device may be configured to receive from a network device, a measurement configuration indicating at least a first network controlled small gap having a first measurement length and a second network controlled small gap having a second measurement length; determine a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

### TECHNICAL FIELD

Various exemplary embodiments generally relate to communication technologies, and more particularly, to devices, methods, apparatuses, and computer readable media for performing measurement with gaps.

### BACKGROUND

In wireless communication systems, a terminal device may be configured with a measurement gap (MG) pattern including one or more MGs to perform measurements on serving carriers (e.g., inter-frequency carriers) or non-serving carriers (e.g., intra-frequency carriers). During the MGs, the terminal device is not expected to receive other signals from the network side or transmit other signals to the network side. In order to mitigate the interruption of communication due to the MG, various enhancements for MG configuration have been introduced in Rel. 17 of 3GPP, such as, pre-configured MGs, multiple concurrent MG patterns, and network controlled small gaps (NCSG).

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for more detailed description provided below.

In a first aspect, an example embodiment of a terminal device is provided. The terminal device may comprise at least one processor and at least one memory storing instructions. The instructions may, when executed by the at least one processor, cause the terminal device at least to receive from a network device, a measurement configuration indicating at least a first network controlled small gap having a first measurement length and a second network controlled small gap having a second measurement length; determine a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

In a second aspect, an example embodiment of a network device is provided. The network device may comprise at least one processor and at least one memory storing instructions. The instructions may, when executed by the at least one processor, cause the network device at least to receive from a terminal device, a capability report indicating that the terminal device has a capability of handling overlapping network controlled small gaps; and send to the terminal device, a measurement configuration indicating at least a first network controlled small gap having a first measurement length and a second network controlled small gap having a second measurement length, the first measurement length overlapping the second measurement length in time domain or a time interval between the first measurement length and the second measurement length being insufficient to accommodate respective interruption lengths for the first measurement length and the second measurement length.

In a third aspect, an example embodiment of a method implemented at a terminal device is provided. The method may comprise receiving from a network device, a measurement configuration indicating at least a first network controlled small gap having a first measurement length and a second network controlled small gap having a second measurement length; determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

In a fourth aspect, an example embodiment of a method implemented at a network device is provided. The method may comprise receiving from a terminal device, a capability report indicating that the terminal device has a capability of handling overlapping network controlled small gaps; and sending to the terminal device, a measurement configuration indicating at least a first network controlled small gap having a first measurement length and a second network controlled small gap having a second measurement length, the first measurement length overlapping the second measurement length in time domain or a time interval between the first measurement length and the second measurement length being insufficient to accommodate respective interruption lengths for the first measurement length and the second measurement length.

In a fifth aspect, an example embodiment of an apparatus is provided. The apparatus as a terminal device may comprise means for receiving from a network device, a measurement configuration indicating at least a first network controlled small gap having a first measurement length and a second network controlled small gap having a second measurement length; means for determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

In a sixth aspect, an example embodiment of an apparatus is provided. The apparatus as a network device may comprise means for receiving from a terminal device, a capability report indicating that the terminal device has a capability of handling overlapping network controlled small gaps; and means for sending to the terminal device, a measurement configuration indicating at least a first network controlled small gap having a first measurement length and a second network controlled small gap having a second measurement length, the first measurement length overlapping the second measurement length in time domain or a time interval between the first measurement length and the second measurement length being insufficient to accommodate respective interruption lengths for the first measurement length and the second measurement length.

In a seventh aspect, an example embodiment of a computer readable medium is provided. The computer readable medium may comprise instructions stored thereon, and the instructions may, when executed by a terminal device, cause the terminal device to perform at least the following: receiving from a network device, a measurement configuration indicating at least a first network controlled small gap having a first measurement length and a second network controlled small gap having a second measurement length; determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

In an eighth aspect, an example embodiment of a computer readable medium is provided. The computer readable medium may comprise instructions stored thereon, and the instructions may, when executed by a network device, cause the network device to perform at least the following: receiving from a terminal device, a capability report indicating that the terminal device has a capability of handling overlapping network controlled small gaps; and sending to the terminal device, a measurement configuration indicating at least a first network controlled small gap having a first measurement length and a second network controlled small gap having a second measurement length, the first measurement length overlapping the second measurement length In time domain or a time interval between the first measurement length and the second measurement length being insufficient to accommodate respective interruption lengths for the first measurement length and the second measurement length.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 illustrates a diagram of colliding measurements of concurrent network controlled small gap (NCSG) patterns.

FIG. 2 is an exemplary sequence diagram illustrating example operations for performing parallel NCSG based measurements according to example embodiments the present disclosure.

FIG. 3 shows an exemplary sequence diagram illustrating example operations for reporting capability of handling overlapping NCSGs.

FIG. 4A and FIG. 4B illustrate exemplary diagrams of the adjusted NCSG patterns according to example embodiments the present disclosure.

FIG. 5 shows a flow chart illustrating an example method implemented at a terminal device according to example embodiments of the present disclosure.

FIG. 6 shows a flow chart illustrating an example method implemented at a network device according to example embodiments of the present disclosure.

FIG. 7 shows a block diagram illustrating an example device for performing measurements with gaps according to example embodiments of the present disclosure.

FIG. 8 shows a block diagram illustrating an example device for performing measurements with gaps according to example embodiments of the present disclosure.

FIG. 9 shows a block diagram illustrating an example apparatus for performing measurements with gaps according to example embodiments of the present disclosure.

FIG. 10 shows a block diagram illustrating an example apparatus for performing measurements with gaps according to example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (dUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

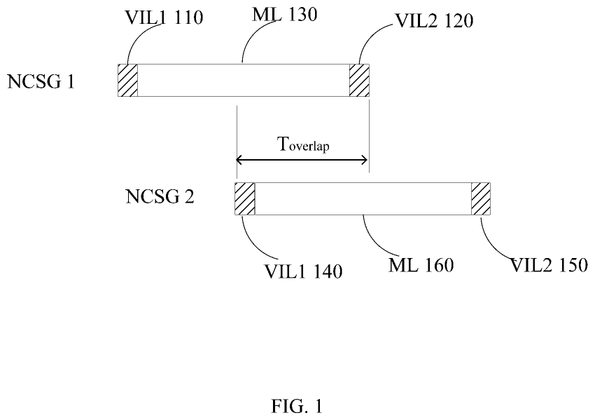

As described above, in the wireless communication system, the terminal device may be configured with a NCSG to reduce the interruption time for scheduling data on uplink or downlink on the serving carrier caused by the measurement. An example use scenario of the NCSG may include a terminal device having a vacant RF chain which can be used to perform measurements. FIG. 1 illustrates an exemplary diagram of an NCSG pattern to which the example embodiments according to the present disclosure may be implemented.

Referring to the FIG. 1, a NCSG pattern 1, shown as NCSG 1 in the FIG. 1, may include a visible interruption length (VIL) 1 110 at the start of the NCSG pattern 1 and a VIL2 120 at the end of the NCSG pattern 1, and a measurement length (ML) 130 between the VIL1 and VIL2. During the VIL1 and VIL2, the terminal device (e.g. a UE) configured with the NCSG 1 is not expected to transmit and/or receive any data. During the ML, the UE may be capable of both communicating on the serving carrier(s) and performing measurements on non-serving carriers. Thus, an advantage of the NCSG is the lower interruption time for scheduling data on uplink and/or downlink on the serving carrier by using a vacant receiver chain for measurements such as neighbor cell measurements, because the interruption time is limited to the VIL1 and VIL2. The VIL can be for example 1 ms for FR1 and 0.75 ms for FR2.

For example, the procedure for performing measurements within NCSG using a vacant RF chain may be as follows. The UE may calculate the start time Tₛₜₐᵣₜ of the measurement window (e.g, ML), and activate the vacant RF chain before the start time at a time point offset from the Tₛₜₐᵣₜ, e.g., by the VIL1. Then, the UE may retune the vacant RF chain to the frequency where the measurement will be performed. During this operation, an interruption is expected on one or more of the active RF chains (i.e. on the serving carriers). During the ML period, the UE may perform the measurement on a given frequency. At the end of the ML, the UE may deactivate the vacant RF chain. During this operation, an interruption is also expected on one or more of the active RF chains.

An enhancement for the NCSG pattern is to configure multiple concurrent NCSG patterns for a UE, so that two or more joint measurements can be performed. Still referring to FIG. 1, for example, the UE may be configured with an additional NCSG pattern 2, shown as NCSG 2 in the FIG. 1, for performing measurement on another neighbor carrier. Similar to NCSG 1, the NCSG 2 may include a VIL1 140, a VIL2 150, and an ML 160 between the VIL1 and VIL2. In an example, the NCSG 2 may have a length that is the same or different from that of the NCSG 1.

When a plurality of NCSG patterns are concurrently configured for a terminal device, the plurality of NCSG patterns may be overlapping in the time domain due to overlapping of measured reference signals (e.g., synchronization signal block (SSB)) on different frequency layers. As shown in FIG. 1, the NCSG 1 and NCSG 2 overlap in a time period Tₒᵥₑᵣₗₐₚ, which may result in interferences between the two NCSG patterns. For example, the pre-interruption window of NCSG 2, i.e., VIL1 140, interferes with the ML 130 of NCSG 1, and the post-interruption window of NCSG 1, i.e., VIL2 120, interferes with the ML 160 of NCSG 2. In FIG. 1, two NCSG patterns are shown as an example, and it may be appreciated that in case of plurality of NCSG patterns, interference may also happen. The interference may impact negatively or even falsify measurements on both carriers.

Hereinafter, example embodiments of methods and apparatuses supporting concurrent NCSG patterns would be described in detail with reference to the drawings. According to the example embodiments of the present disclosure, any potential interruptions are placed outside the measurement periods for any of concurrent NCSG patterns. The example embodiments allow a terminal to perform two or more NCSG based measurements simultaneously without collision. Thus, the Radio Resource Management (RRM) performance may be enhanced.

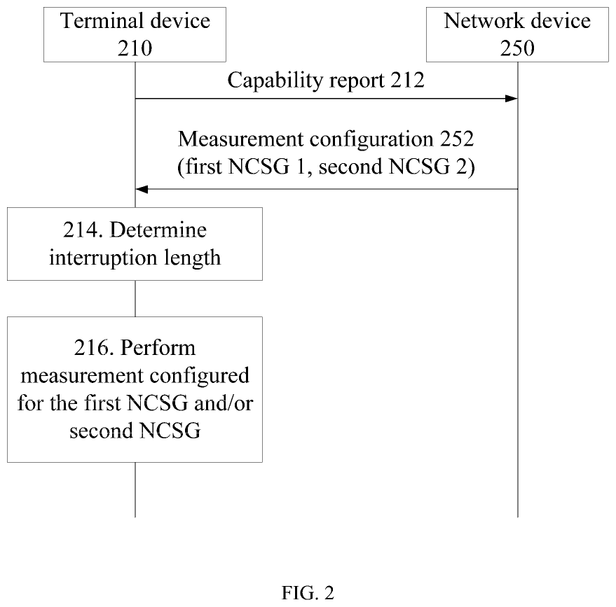

FIG. 2 is an exemplary sequence diagram illustrating example operations for performing parallel NCSG based measurements according to an example embodiment. In some implementations, the operations shown in FIG. 2 may be performed by a terminal device 210 and a network device 250. The terminal device 210 may represent any terminal device in a wireless communication system, and the network device 250 may function as the network side serving the terminal device 210.

Referring to FIG. 2, the terminal device 210 may transmit a capability report 212 of handling overlapping NCSGs to the network device 250. In an example, the capability report 212 of handling overlapping NCSGs may indicate that the terminal device 210 has a capability of handling overlapping NCSGs.

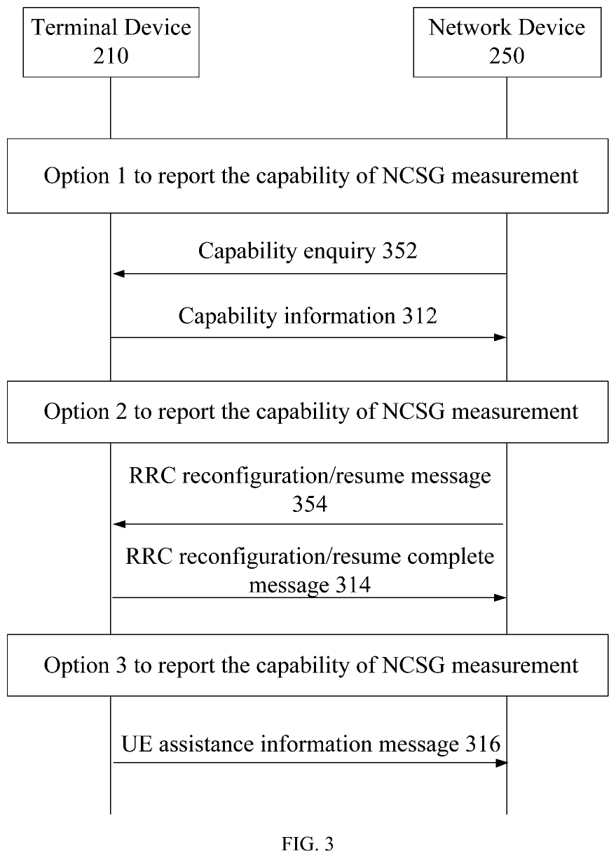

In some embodiments, the terminal device 210 may report the capability of handling overlapping NCSGs to the network device 250 via a radio resource control (RRC) message. FIG. 3 shows an exemplary sequence diagram illustrating example operations for reporting capability of handling overlapping NCSGs.

Referring to FIG. 3, in an example embodiment, as an option, the UE capability information may be generated in response to an enquiry by the network device 250. For example, the network device 250 may transmit a UE capability enquiry 352 to the terminal device 210. The enquiry message may include operating bands of interest, such as bands of the serving cell and neighboring cells. In response, the terminal device 210 may generate and report the UE capability information 312 for one or more of the bands. As an example, the terminal device 210 may report its capability of handling overlapping NCSGs for each band combination. The band combination may include bands that the terminal device 210 may be served and to be measured. As another example, when the terminal device 210 support all use cases, it may report a single capability by using, e.g., a one-bit indication, to indicate the capability for all band combinations.

In an example embodiment, as an option, the capability information may be exchanged in a dynamic way. For example, the network device 250 may transmit an RRC reconfiguration message or an RRC resume message 354 to the terminal device 210. The RRC reconfiguration/resume message 354 may include an indication of whether NCSG is required for the terminal device 210 to perform SSB based measurements on a target band combination. Then the terminal device 210 may report the capability information, e.g., via an RRC reconfiguration complete message or an RRC resume complete message 314, according to the band combination and physical layer configurations (e.g., MIMO). Through this RRC message, the terminal device 210 may report its capability in a more flexible way so that it needs not support all use cases of overlapping bands.

In an example embodiment, as an option, the capability information may be included in a terminal device (UE) assistance information message 316. For example, the terminal device 210 may transmit the UE assistance information message 316 including the capability information to provide the network device 250 with information that may assist the network device 250 to configure the NCSG patterns in the terminal device 210.

Referring back to the FIG. 2, the network device 250 may send a measurement configuration 252 indicating at least a first NCSG 1 having a first measurement length (or measurement window) and a second NCSG 2 having a second measurement length to the terminal device 210.

Receiving the measurement configuration 252, in an operation 214, the terminal device 210 may determine a first interruption length prior to (i.e., before) the first measurement length, a second interruption length post to (i.e., subsequent to or after) the first measurement length, a third interruption length prior to the second measurement length, and a fourth interruption length post to the second measurement length. The first interruption length may be for example the VIL1 110 shown in the FIG. 1, the second interruption length may be for example the VIL2 120 shown in the FIG. 1, the third interruption length may be for example the VIL1 140 shown in the FIG. 1, and the fourth interruption length may be for example the VIL2 150 shown in the FIG. 1. In an example embodiment, the first measurement length (i.e., measurement window) 130 may have a duration identical to or different from that of the second measurement length 160, the VIL1 110 and the VIL2 120 may have a duration identical to or different from that of the VIL1 140 and the VIL2 150.

In the example scenario shown in the FIG. 1, the ML 130 which may be the first measurement length overlaps the ML 160 which may be the second measurement length in time domain. Alternatively, even the first measurement length and the second measurement length do not overlap, in some scenarios, a time interval between the first measurement length and the second measurement length may be insufficient to accommodate respective interruption lengths, e.g. the VIL1 140 and/or the VIL2 120 for the first measurement length and the second measurement length.

In this case, in the operation 214, the terminal device 210 may determine the first interruption length 110, the second interruption length 120, the third interruption length 140 and the fourth interruption length 150 being positioned outside a combined duration of the first measurement length 130 and the second measurement length 160 in a case where the first measurement length 130 overlaps the second measurement length 160 or a time interval between the first measurement length 130 and the second measurement length 160 is insufficient to accommodate the second interruption length 120 for the first measurement length 130 and the third interruption length 140 for the second measurement length 160. Here the combined duration of the first measurement length 130 and the second measurement length 160 may refer to a time period from the starting time point of the first measurement length 130 to the ending time point of the second measurement length 160.

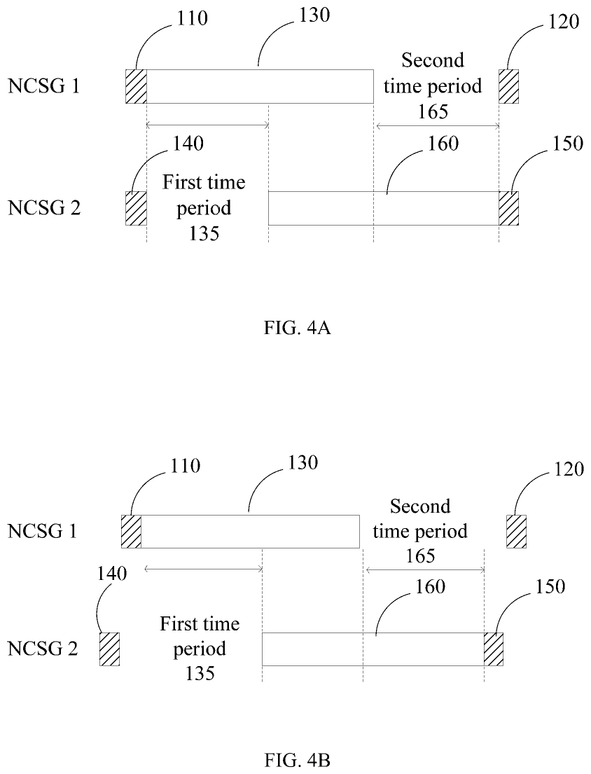

FIG. 4A and FIG. 4B illustrate exemplary diagrams of the NCSG patterns adjusted from the FIG. 1 according to the example embodiments the present disclosure.

In some embodiments, in a case where the terminal device 210 is capable to activate and retune more than one vacant RF chains at a time, as is shown in the FIG. 4A, the first interruption length 110 prior to the first measurement length 130 may be aligned in the time domain with the third interruption length 140 prior to the second measurement length 160. Then the terminal device 210 may activate and retune multiple vacant RF chains simultaneously. In a case where the terminal device 210 is incapable to activate or retune more than one vacant RF chains at a time, as is shown in the FIG. 4B, the first interruption length 110 prior to the first measurement length 130 may be offset in the time domain from the third interruption length 140 prior to the second measurement length 160. For example, the second interruption length 140 may be positioned prior to the first interruption length 110, or vice versa. Then the terminal device 210 may activate and retune multiple vacant RF chains one by one. In a further example embodiment, retuning the RF chain may include multiple steps of which some steps may be performed in parallel. Then the first interruption length 110 may partially overlap with the third measurement length 140.

In some embodiments, in a case where the terminal device 210 is capable to deactivate more than one vacant RF chains at a time, as is shown in the FIG. 4A, the second interruption length 120 post to the first measurement length 130 may be aligned in the time domain with the fourth interruption length 150 post to the second measurement length 160. Then the terminal device 210 may deactivate the multiple vacant RF chains simultaneously after measurements during the first measurement length 130 and the second measurement length 160. In a case where the terminal device 210 is incapable to deactivate more than one vacant RF chains at a time, as is shown in the FIG. 4B, the second interruption length 120 post to the first measurement length 130 may be offset in the time domain from the fourth interruption length 150 post to the second measurement length 160. For example, the second interruption length 120 may be positioned after the fourth interruption length 150. Then the terminal device 210 may deactivate the multiple vacant RF chains one by one after measurements during the first measurement length 130 and the second measurement length 160. In a further example embodiment, deactivating the RF chain may include multiple steps of which some steps may be performed in parallel. Then the second interruption length 120 may partially overlap with the fourth measurement length 150.

Then, in an operation 216 shown in the FIG. 2, the terminal device 210 may perform measurement configured for the first NCSG 1 and/or the second NCSG 2. In some embodiments, in a case where two RF chains are available, the terminal device 210 may perform a first measurement configured for the first NCSG 1 and a second measurement configured for the second NCSG 2 using the two RF chains, respectively. Alternatively, in some embodiments, in a case where one of the two RF chains is unavailable, the terminal device 210 may drop one of the first measurement and the second measurement with a lower priority and perform the other of the first measurement and the second measurement with a higher priority.

In some embodiments, the first NCSG 1 may be configured for a first frequency band, and the second NCSG 2 may be configured for a second frequency band. As is shown in the FIG. 4A and the FIG. 4B, in a case where the first measurement length 130 of the first NCSG 1 has a starting position prior to that of the second measurement length 160 of the second NCSG 2, a first time period 135 from the starting position of the first measurement length to the starting position of the second measurement length may be scheduled for further measurement in the second frequency band, or for data transmission and/or reception in the second frequency band if the terminal device 210 has capability of simultaneous reception and transmission in the first frequency band and the second frequency band.

In some embodiments, as is shown in the FIG. 4A and the FIG. 4B, in a case where the first measurement length 130 of the first NCSG 1 has an ending position prior to that of the second measurement length 160 of the second NCSG 2, a second time period 165 from the ending position of the first measurement length 130 to the ending position of the second measurement length 160 may be scheduled for further measurement in the first frequency band, or for data transmission and/or reception in the first frequency band if the terminal device 210 has capability of simultaneous reception and transmission in the first frequency band and the second frequency band.

In some embodiments, the further measurement in the first frequency band may be targeted to a first measurement object configured for the first NCSG 1, and the further measurement in the second frequency band may be targeted to a second measurement object configured for the second NCSG 2. In this case, the further measurement in the first frequency band may be identical to the measurement in the measurement length 130, and the further measurement in the second frequency band may be identical to the measurement in the measurement length 160.

In the above example embodiments, two NCSG patterns, NCSG 1 and NCSG 2 are described as example. It may be appreciated that the example embodiments according to the present disclosure may also apply in the cases where more than two NCSG patterns are configured for a terminal device.

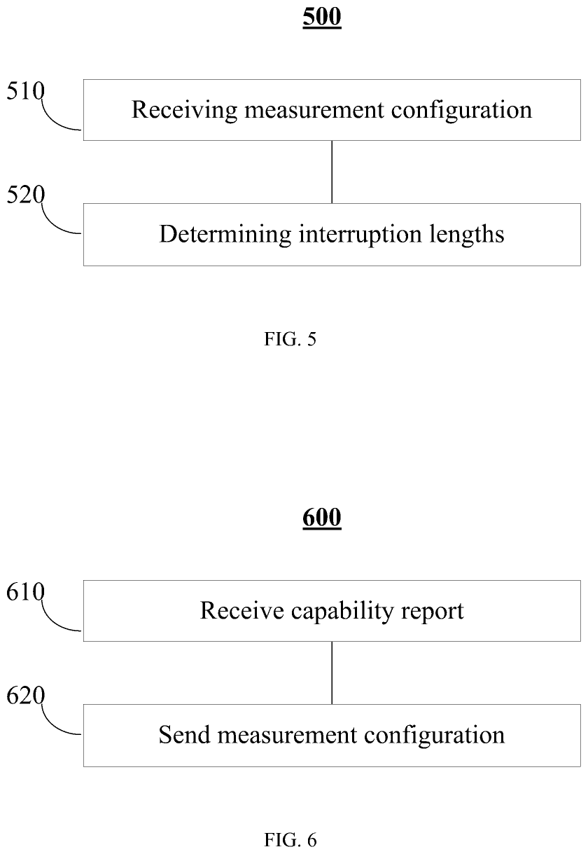

FIG. 5 shows a flow chart illustrating an example method 500 implemented at a terminal device according to the example embodiments of the present disclosure. The example method 500 may be performed for example by a terminal device such as the terminal device 210 above mentioned.

Referring to the FIG. 5, the example method 500 may include, an operation 510 of receiving from a network device, a measurement configuration indicating at least a first network controlled small gap having a first measurement length and a second network controlled small gap having a second measurement length; an operation 520 of determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

In some embodiments, the first interruption length prior to the first measurement length is aligned in the time domain with the third interruption length prior to the second measurement length, or the first interruption length prior to the first measurement length is offset in the time domain from or partially overlaps with the third interruption length prior to the second measurement length.

In some embodiments, the second interruption length post to the first measurement length is aligned in the time domain with the fourth interruption length post to the second measurement length, or the second interruption length post to the first measurement length is offset in the time domain from or partially overlaps with the fourth interruption length post to the second measurement length.

In some embodiments, the first network controlled small gap is configured for a first frequency band, and the second network controlled small gap is configured for a second frequency band, in a case where the first measurement length of the first network controlled small gap has a starting position prior to that of the second measurement length of the second network controlled small gap, a first time period from the starting position of the first measurement length to the starting position of the second measurement length is scheduled for further measurement in the second frequency band, or for data transmission and/or reception in the second frequency band if the terminal device has capability of simultaneous reception and transmission in the first frequency band and the second frequency band.

In some embodiments, in a case where the first measurement length of the first network controlled small gap has an ending position prior to that of the second measurement length of the second network controlled small gap, a second time period from the ending position of the first measurement length to the ending position of the second measurement length is scheduled for further measurement in the first frequency band, or for data transmission and/or reception in the first frequency band if the terminal device has capability of simultaneous reception and transmission in the first frequency band and the second frequency band.

In some embodiments, the further measurement in the first frequency band is targeted to a first measurement object configured for the first network controlled small gap, and the further measurement in the second frequency band is targeted to a second measurement object configured for the second network controlled small gap.

In some embodiments, the method 500 may further comprise: in a case where two radio frequency chains are available, performing a first measurement configured for the first network controlled small gap and a second measurement configured for the second network controlled small gap using the two radio frequency chains, respectively; or in a case where one of the two radio frequency chains is unavailable, dropping one of the first measurement and the second measurement with a lower priority and perform the other of the first measurement and the second measurement with a higher priority.

In some embodiments, the method 500 may further comprise: reporting capability of handling overlapping network controlled small gaps to the network device.

In some embodiments, the terminal device reports the capability of handling overlapping network controlled small gaps to the network device via a radio resource control message.

In some embodiments, the radio resource control message comprises at least one of the following messages: a terminal device capability information message; a radio resource control reconfiguration complete message; a radio resource control resume complete message; or a terminal device assistance information message.

FIG. 6 shows a flow chart illustrating an example method 600 implemented at a network device according to the example embodiments of the present disclosure. The example method 600 may be performed for example by a network device such as the network device 250 above mentioned.

Referring to the FIG. 6, the example method 600 may include, an operation 610 of receiving from a terminal device, a capability report indicating that the terminal device has a capability of handling overlapping network controlled small gaps; and an operation 620 of sending to the terminal device, a measurement configuration indicating at least a first network controlled small gap having a first measurement length and a second network controlled small gap having a second measurement length, the first measurement length overlapping the second measurement length in time domain or a time interval between the first measurement length and the second measurement length being insufficient to accommodate respective interruption lengths for the first measurement length and the second measurement length.

In some embodiments, the capability report is received via a radio resource control message.

In some embodiments, the radio resource control message comprises at least one of the following messages: a terminal device capability information message; a radio resource control reconfiguration complete message; a radio resource control resume complete message; or a terminal device assistance information message.

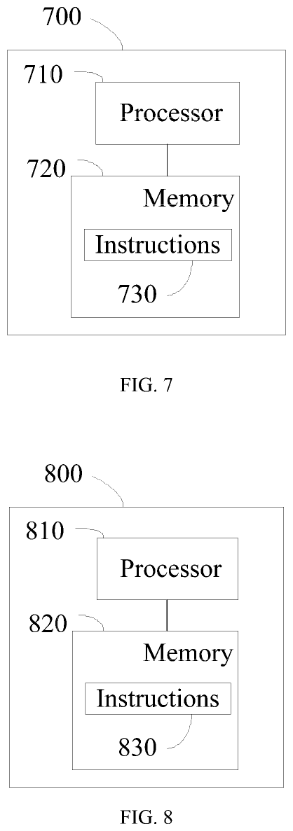

FIG. 7 shows a block diagram illustrating an example device 700 for performing measurements with gaps according to the example embodiments of the present disclosure. The device, for example, may be at least part of a terminal device such as the terminal device 210 in the above examples.

As shown in the FIG. 7, the example device 700 may include at least one processor 710 and at least one memory 720 that may store instructions 730. The instructions 730, when executed by the at least one processor 710, may cause the device 700 at least to perform the example method 500 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the terminal device 210 is not limited to the above example device 700.

FIG. 8 shows a block diagram illustrating an example device 800 for performing measurements with gaps according to the example embodiments of the present disclosure. The device, for example, may be at least part of a network device such as the network device 250 in the above examples.

As shown in the FIG. 8, the example device 800 may include at least one processor 810 and at least one memory 820 that may store instructions 830. The instructions 830, when executed by the at least one processor 810, may cause the device 800 at least to perform the example method 600 described above.

In various example embodiments, the at least one processor 810 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example device 800 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 820 may include, but are not limited to, an electric, a magnetic, an optical, an electromagnetic, an infrared, or a semiconductor system, apparatus, or device or any combination of the above.

Further, in various example embodiments, the example device 800 may also include at least one other circuitry, element, and interface, for example at least one I/O interface, at least one antenna element, and the like.

In various example embodiments, the circuitries, parts, elements, and interfaces in the example device 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 250 is not limited to the above example device 800.

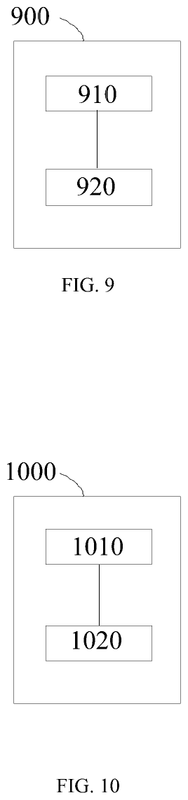

FIG. 9 shows a block diagram illustrating an example apparatus 900 for performing measurements with gaps according to the example embodiments of the present disclosure. The apparatus, for example, may be at least part of a terminal device such as the terminal device 210 in the above examples.

As shown in the FIG. 9, the example apparatus 900 may comprise: means for receiving from a network device, a measurement configuration indicating at least a first network controlled small gap having a first measurement length and a second network controlled small gap having a second measurement length; means for determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain, or a time interval between the first measurement length and the second measurement length is insufficient to accommodate respective interruption lengths for the first measurement length and the second measurement length.

In some embodiments, the first interruption length prior to the first measurement length is aligned in the time domain with the third interruption length prior to the second measurement length, or the first interruption length prior to the first measurement length is offset in the time domain from or partially overlaps with the third interruption length prior to the second measurement length.

In some embodiments, the second interruption length post to the first measurement length is aligned in the time domain with the fourth interruption length post to the second measurement length, or the second interruption length post to the first measurement length is offset in the time domain from or partially overlaps with the fourth interruption length post to the second measurement length.

In some embodiments, the first network controlled small gap is configured for a first frequency band, and the second network controlled small gap is configured for a second frequency band, in a case where the first measurement length of the first network controlled small gap has a starting position prior to that of the second measurement length of the second network controlled small gap, a first time period from the starting position of the first measurement length to the starting position of the second measurement length is scheduled for further measurement in the second frequency band, or for data transmission and/or reception in the second frequency band if the terminal device has capability of simultaneous reception and transmission in the first frequency band and the second frequency band.

In some embodiments, in a case where the first measurement length of the first network controlled small gap has an ending position prior to that of the second measurement length of the second network controlled small gap, a second time period from the ending position of the first measurement length to the ending position of the second measurement length is scheduled for further measurement in the first frequency band, or for data transmission and/or reception in the first frequency band if the terminal device has capability of simultaneous reception and transmission in the first frequency band and the second frequency band.

In some embodiments, the further measurement in the first frequency band is targeted to a first measurement object configured for the first network controlled small gap, and the further measurement in the second frequency band is targeted to a second measurement object configured for the second network controlled small gap.

In some embodiments, the example apparatus 900 may further comprise: means for in a case where two radio frequency chains are available, performing a first measurement configured for the first network controlled small gap and a second measurement configured for the second network controlled small gap using the two radio frequency chains, respectively; or in a case where one of the two radio frequency chains is unavailable, dropping one of the first measurement and the second measurement with a lower priority and perform the other of the first measurement and the second measurement with a higher priority.

In some embodiments, the example apparatus 900 may further comprise: means for reporting capability of handling overlapping network controlled small gaps to the network device.

In some embodiments, the terminal device reports the capability of handling overlapping network controlled small gaps to the network device via a radio resource control message.

In some embodiments, the radio resource control message comprises at least one of the following messages: a terminal device capability information message; a radio resource control reconfiguration complete message; a radio resource control resume complete message; or a terminal device assistance information message.

In some example embodiments, examples of means in the example apparatus 900 may include circuitries. For example, an example of means 910 may include a circuitry configured to perform the operation 510 of the example method 500, and an example of means 920 may include a circuitry configured to perform the operation 520 of the example method 500.

The example apparatus 900 may further include means comprising circuitry configured to perform the example method 500. In some example embodiments, examples of means may also include software modules and any other suitable function entities.

FIG. 10 shows a block diagram illustrating an example apparatus 1000 for performing measurements with gaps according to the example embodiments of the present disclosure. The apparatus, for example, may be at least part of a terminal device such as the network device 250 in the above examples.

As shown in the FIG. 10, the example apparatus 1000 may comprise: means for receiving from a terminal device, a capability report indicating that the terminal device has a capability of handling overlapping network controlled small gaps; and means for sending to the terminal device, a measurement configuration indicating at least a first network controlled small gap having a first measurement length and a second network controlled small gap having a second measurement length, the first measurement length overlapping the second measurement length in time domain or a time interval between the first measurement length and the second measurement length being insufficient to accommodate respective interruption lengths for the first measurement length and the second measurement length.

In some embodiments, the capability report is received via a radio resource control message.

In some embodiments, the radio resource control message comprises at least one of the following messages: a terminal device capability information message; a radio resource control reconfiguration complete message; a radio resource control resume complete message; or a terminal device assistance information message.

In some example embodiments, examples of means in the example apparatus 1000 may include circuitries. For example, an example of means 1010 may include a circuitry configured to perform the operation 610 of the example method 600, and an example of means 1020 may include a circuitry configured to perform the operation 620 of the example method 600.

The example apparatus 1000 may further include means comprising circuitry configured to perform the example method 600. In some example embodiments, examples of means may also include software modules and any other suitable function entities.

The example embodiments of the present disclosure also provide a computer readable medium comprising program instructions that, when executed by a terminal device such as the terminal device 210 in the above examples, may cause the terminal device 210 at least to perform: receiving from a network device, a measurement configuration indicating at least a first network controlled small gap having a first measurement length and a second network controlled small gap having a second measurement length; determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

In some embodiments, the first interruption length prior to the first measurement length is aligned in the time domain with the third interruption length prior to the second measurement length, or the first interruption length prior to the first measurement length is offset in the time domain from or partially overlaps with the third interruption length prior to the second measurement length.

In some embodiments, the second interruption length post to the first measurement length is aligned in the time domain with the fourth interruption length post to the second measurement length, or the second interruption length post to the first measurement length is offset in the time domain from or partially overlaps with the fourth interruption length post to the second measurement length.

In some embodiments, the first network controlled small gap is configured for a first frequency band, and the second network controlled small gap is configured for a second frequency band, in a case where the first measurement length of the first network controlled small gap has a starting position prior to that of the second measurement length of the second network controlled small gap, a first time period from the starting position of the first measurement length to the starting position of the second measurement length is scheduled for further measurement in the second frequency band, or for data transmission and/or reception in the second frequency band if the terminal device has capability of simultaneous reception and transmission in the first frequency band and the second frequency band.

In some embodiments, in a case where the first measurement length of the first network controlled small gap has an ending position prior to that of the second measurement length of the second network controlled small gap, a second time period from the ending position of the first measurement length to the ending position of the second measurement length is scheduled for further measurement in the first frequency band, or for data transmission and/or reception in the first frequency band if the terminal device has capability of simultaneous reception and transmission in the first frequency band and the second frequency band.

In some embodiments, the further measurement in the first frequency band is targeted to a first measurement object configured for the first network controlled small gap, and the further measurement in the second frequency band is targeted to a second measurement object configured for the second network controlled small gap.

In some embodiments, the computer readable medium may further include instructions that, when executed by the terminal device 210, may cause the network device to further perform: in a case where two radio frequency chains are available, performing a first measurement configured for the first network controlled small gap and a second measurement configured for the second network controlled small gap using the two radio frequency chains, respectively; or in a case where one of the two radio frequency chains is unavailable, dropping one of the first measurement and the second measurement with a lower priority and perform the other of the first measurement and the second measurement with a higher priority.

In some embodiments, the computer readable medium may further include instructions that, when executed by the terminal device 210, may cause the network device to further perform: reporting capability of handling overlapping network controlled small gaps to the network device.

In some embodiments, the terminal device reports the capability of handling overlapping network controlled small gaps to the network device via a radio resource control message.

In some embodiments, the radio resource control message comprises at least one of the following messages: a terminal device capability information message; a radio resource control reconfiguration complete message; a radio resource control resume complete message; or a terminal device assistance information message.

The example embodiments of the present disclosure also provide a computer readable medium comprising program instructions that, when executed by a network device such as the network device 250 in the above examples, may cause the network device 250 at least to perform: receiving from a terminal device, a capability report indicating that the terminal device has a capability of handling overlapping network controlled small gaps; and sending to the terminal device, a measurement configuration indicating at least a first network controlled small gap having a first measurement length and a second network controlled small gap having a second measurement length, the first measurement length overlapping the second measurement length in time domain or a time interval between the first measurement length and the second measurement length being insufficient to accommodate respective interruption lengths for the first measurement length and the second measurement length.

In some embodiments, the capability report is received via a radio resource control message.

In some embodiments, the radio resource control message comprises at least one of the following messages: a terminal device capability information message; a radio resource control reconfiguration complete message; a radio resource control resume complete message; or a terminal device assistance information message.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

Certain abbreviations that may be found in the description and/or in the figures are herewith defined as follows:
MG Measurement Gap
ML Measurement Length
NCSG Network controlled small gaps
RRC radio resource control
RRM radio resource management
SSB Synchronization Signal Block
VIL Visible Interruption Length
UE User Equipment

1. A terminal device comprising:
at least one processor; and
at least one memory storing instructions that, when executed by the at least one processor, cause the terminal device at least to:
receive from a network device, a measurement configuration indicating at least a first network controlled small gap having a first measurement length and a second network controlled small gap having a second measurement length;
determine a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

2. The terminal device of claim 1, wherein the first interruption length prior to the first measurement length is aligned in the time domain with the third interruption length prior to the second measurement length, or
the first interruption length prior to the first measurement length is offset in the time domain from or partially overlaps with the third interruption length prior to the second measurement length.

3. The terminal device of claim 1, wherein the second interruption length post to the first measurement length is aligned in the time domain with the fourth interruption length post to the second measurement length, or
the second interruption length post to the first measurement length is offset in the time domain from or partially overlaps with the fourth interruption length post to the second measurement length.

4. The terminal device of claim 1, wherein the first network controlled small gap is configured for a first frequency band, and the second network controlled small gap is configured for a second frequency band,
in a case where the first measurement length of the first network controlled small gap has a starting position prior to that of the second measurement length of the second network controlled small gap, a first time period from the starting position of the first measurement length to the starting position of the second measurement length is scheduled for further measurement in the second frequency band, or for data transmission and/or reception in the second frequency band if the terminal device has capability of simultaneous reception and transmission in the first frequency band and the second frequency band.

5. The terminal device of claim 4, wherein in a case where the first measurement length of the first network controlled small gap has an ending position prior to that of the second measurement length of the second network controlled small gap, a second time period from the ending position of the first measurement length to the ending position of the second measurement length is scheduled for further measurement in the first frequency band, or for data transmission and/or reception in the first frequency band if the terminal device has capability of simultaneous reception and transmission in the first frequency band and the second frequency band.

6. The terminal device of claim 5, wherein the further measurement in the first frequency band is targeted to a first measurement object configured for the first network controlled small gap, and the further measurement in the second frequency band is targeted to a second measurement object configured for the second network controlled small gap.

7. The terminal device of claim 1, wherein the at least one memory further stores instructions that, when executed by the at least one processor, cause the terminal device at least to:
in a case where two radio frequency chains are available, perform a first measurement configured for the first network controlled small gap and a second measurement configured for the second network controlled small gap using the two radio frequency chains, respectively; or
in a case where one of the two radio frequency chains is unavailable, drop one of the first measurement and the second measurement with a lower priority and perform the other of the first measurement and the second measurement with a higher priority.

8. The terminal device of claim 1, wherein the at least one memory further stores instructions that, when executed by the at least one processor, cause the terminal device to:
report capability of handling overlapping network controlled small gaps to the network device.

9. The terminal device of claim 8, wherein the terminal device reports the capability of handling overlapping network controlled small gaps to the network device via a radio resource control message.

10. The terminal device of claim 9, wherein the radio resource control message comprises at least one of the following messages:
a terminal device capability information message;
a radio resource control reconfiguration complete message;
a radio resource control resume complete message; or
a terminal device assistance information message.

11-13. (canceled)

14. A method implemented at a terminal device comprising:
receiving from a network device, a measurement configuration indicating at least a first network controlled small gap having a first measurement length and a second network controlled small gap having a second measurement length;
determining a first interruption length prior to the first measurement length, a second interruption length post to the first measurement length, a third interruption length prior to the second measurement length, and a fourth interruption length post to the second measurement length, the first interruption length, the second interruption length, the third interruption length and the fourth interruption length being positioned outside a combined duration of the first measurement length and the second measurement length in a case where the first measurement length overlaps the second measurement length in time domain or a time interval between the first measurement length and the second measurement length is insufficient to accommodate respective interruption lengths for the first measurement length and the second measurement length.

15. The method of claim 14, wherein the first interruption length prior to the first measurement length is aligned in the time domain with the third interruption length prior to the second measurement length, or
the first interruption length prior to the first measurement length is offset in the time domain from or partially overlaps with the third interruption length prior to the second measurement length.

16. The method of claim 14, wherein the second interruption length post to the first measurement length is aligned in the time domain with the fourth interruption length post to the second measurement length, or
the second interruption length post to the first measurement length is offset in the time domain from or partially overlaps with the fourth interruption length post to the second measurement length.

17. The method of claim 14, wherein the first network controlled small gap is configured for a first frequency band, and the second network controlled small gap is configured for a second frequency band,
in a case where the first measurement length of the first network controlled small gap has a starting position prior to that of the second measurement length of the second network controlled small gap, a first time period from the starting position of the first measurement length to the starting position of the second measurement length is scheduled for further measurement in the second frequency band, or for data transmission and/or reception in the second frequency band if the terminal device has capability of simultaneous reception and transmission in the first frequency band and the second frequency band.

18. The method of claim 17, wherein in a case where the first measurement length of the first network controlled small gap has an ending position prior to that of the second measurement length of the second network controlled small gap, a second time period from the ending position of the first measurement length to the ending position of the second measurement length is scheduled for further measurement in the first frequency band, or for data transmission and/or reception in the first frequency band if the terminal device has capability of simultaneous reception and transmission in the first frequency band and the second frequency band.

19. The method of claim 18, wherein the further measurement in the first frequency band is targeted to a first measurement object configured for the first network controlled small gap, and the further measurement in the second frequency band is targeted to a second measurement object configured for the second network controlled small gap.

20. The method of claim 14, further comprising:
in a case where two radio frequency chains are available, performing a first measurement configured for the first network controlled small gap and a second measurement configured for the second network controlled small gap using the two radio frequency chains, respectively; or
in a case where one of the two radio frequency chains is unavailable, dropping one of the first measurement and the second measurement with a lower priority and perform the other of the first measurement and the second measurement with a higher priority.

21. The method of claim 14, further comprising:
reporting capability of handling overlapping network controlled small gaps to the network device.

22. The method of claim 21, wherein the terminal device reports the capability of handling overlapping network controlled small gaps to the network device via a radio resource control message.

23. The method of claim 22, wherein the radio resource control message comprises at least one of the following messages:
a terminal device capability information message;
a radio resource control reconfiguration complete message;
a radio resource control resume complete message; or
a terminal device assistance information message.

24-34. (canceled)
